(19) United States
(12) Patent Application Publication
(10) Pub. No.: US 2011/0035160 A1
(43) Pub. Date: Feb. 10, 2011

(54) Multi-Channel Bio Reactor with Fluorescence Detector and On-Line Monitoring Apparatus of It

(75) Inventors: Jong IL Rhee, Gwangju (KR); Ok-Jae Sohn, Jeollanam-do (KR)

Correspondence Address: THE WEBB LAW FIRM, P.C., 700 KOPPERS BUILDING, 436 SEVENTH AVENUE, PITTSBURGH, PA, 15219, US

(73) Assignee: INDUSTRY FOUNDATION OF CHONNAM NATIONAL UNIVERSITY, Gwangju (KR)

(21) Appl. No.: 12/936,650

(22) PCT Filed: Apr. 8, 2009
(86) PCT No.: PCT/KR09/01808

§ 371 Date: Oct. 6, 2010

(30) Foreign Application Priority Data
Apr. 8, 2008 (KR) 10-2008-0032496

(51) Int. Cl. G01N 21/64; G06F 19/00

(52) U.S. Cl. 702/22; 250/458.1; 250/239; 250/226; 250/227.23; 250/227.24

(57) ABSTRACT

Disclosed is a multi-channel bio reactor with fluorescence detector which measures various bio-chemical materials using fluorescence analysis, and an on-line monitoring apparatus of it. The multi-channel bio reactor with fluorescence detector comprises a light source 10 for emitting excitation light; a light irradiation part 30 for irradiating the excitation light emitted from the light source 10; a sample receiving part 40 in which the excitation light irradiated from the light irradiation part 30 is irradiated on a sample and which has a plurality of walls 41 for receiving a sample containing a fluorescent material; and an optical detecting part 50 for detecting fluorescence emitted from the sample received in the wall 41 of the sample receiving part 40.

### TECHNICAL FIELD

The present invention relates to a multi-channel bio reactor with fluorescence detector in which excitation light is irradiated on a sample containing a fluorescent substance so as to detect fluorescence generated by the sample and thus analyze various biochemical materials, and an on-line monitoring apparatus of it.

### BACKGROUND ART

Generally, fluorescence is a phenomenon that, when molecules or atoms of a substance excited from a ground state having a low energy level to an excitation state having a high energy level by absorbing energy from an outside is returned to the ground state, light having a long wavelength comparing with an excitation wavelength is re-emitted. A fluorescence analysis is to measure an amount of a specified substance contained in a sample by detecting light generated by the fluorescence using various optical detectors. A fluorescence detector is an apparatus for measuring properties (concentration of dissolved oxygen, pH, concentration of carbon dioxide, concentration of specified ion and various characteristics of a biochemical material) of the sample using the fluorescence analysis.

In Korean Patent No. 10-0451416, as a conventional apparatus using the fluorescence analysis, there is disclosed an optical system in a fluorescence detection equipment, including a light source for emitting light; a first shielding film formed with an opening so as to allow the light emitted from the light source to partially pass through; a band pass filter provided to allow only the light having a predetermined frequency to pass through; a channel for receiving a sample on which light passing through the first shielding film and the band pass filter is scanned; a second shielding film formed with a shielding portion for shielding light emitted from the light source contained in light emitted from the channel and an opening through which light emitted from the sample passes; and an optical sensor for detecting light passing through the second shielding film. However, since the optical system in the fluorescence detection equipment uses only the light emitted from one light source, it is impossible to measure various characteristics at a time. Therefore, the oxygen concentration, pH, carbon dioxide concentration, specified ion concentration and the various characteristics of a biochemical material can not be measured at a time. Further, since the light source or the band pass filter is different according to the properties, it is necessary to replace the light source or the band pass filter, and thus it takes too much time to measure the properties and also it is difficult to analyze them.

Further, since only one channel contained the sample can be measure at a time, when a plurality of samples are measured, it is also takes too much time to replace the channels.

Furthermore, it is required to develop a monitoring apparatus for controlling the fluorescence detector through on-line.

### DISCLOSURE OF INVENTION

### Technical Problem

An object of the present invention is to provide a multi-channel bio reactor with fluorescence detector in which multiple samples are scanned with time difference by light from a light source of a fluorescence detection system having a plurality of channels so as to measure the samples at a time, thereby reducing a measuring time of the samples.

Another object of the present invention is to provide a multi-channel bio reactor with fluorescence detector which can measure concentration of dissolved oxygen, pH, concentration of carbon dioxide, concentration of specified ion and intensity of fluorescence from a biochemical material at a time in one well.

Yet another object of the present invention is to provide a multi-channel bio reactor with fluorescence detector on-line monitoring apparatus which can control the multi-channel bio reactor with fluorescence detector through on-line.

### Technical Solution

To achieve the above objects, the present invention provides a multi-channel bio reactor with fluorescence detector 100, including a light source 10 for emitting excitation light; a light irradiation part 30 for irradiating the excitation light emitted from the light source 10; a sample receiving part 40 in which the excitation light irradiated from the light irradiation part 30 is irradiated on a sample and which has a plurality of walls 41 for receiving a sample containing a fluorescent material; and an optical detecting part 50 for detecting fluorescence emitted from the sample received in the wall 41 of the sample receiving part 40.

Preferably, the light irradiation part 30 is provided with a block 20 which is formed into one body, and includes a light source coupling port 31 which is coupled with the light source 10, an excitation light irradiating path 32 through which excitation light emitted from the light source 10 is transmitted from the light source coupling port 31, and a band pass filter 33 which is coupled to an end or an internal portion of the excitation light irradiating path 32 placed at an inside portion of the light source 10 so as to pass only the excitation light having a special wavelength emitted from the light source 10.

Preferably, the optical detecting part 50 includes a fluorescence path 51 which is provided at the block 20 of the light irradiation part 30 and through which the fluorescence emitted from the sample received in the well 41 of the sample receiving part 40 is transmitted, a band pass filter 53 which is disposed at the fluorescence path 51, and a detecting sensor 52 which is coupled to an end of the fluorescence path 51 so as to detect the transmitted fluorescence.

Preferably, the light source coupling port 31 and the excitation light irradiating path 32 are provided in plural so as to entirely or independently irradiate the excitation light.

Preferably, the excitation light irradiating path 32 is formed at the surface of the block adjacent to the sample receiving part 40 so as to form an angle of 0 to 90° with respect to the light source coupling port 31.

Preferably, the block 20 is disposed at a lower side of the sample receiving part 40, and a fluorescent sensor film 42 for passing only particular fluorescence emitted from the sample or a fluorescent material for sensing the fluorescence is attached to or coated on a bottom surface of the well 41.

Preferably, the fluorescent sensor film 42 is divided into or mixed with n kinds or more (n=1) so as to measure various characteristics of biochemical materials.

Preferably, the fluorescence path 51 and the detecting sensor 52 of the optical detecting part 50 is comprised of a single detector or a plurality of fluorescent sensor films 42 in which the fluorescent dye is divided or mixed so as to detect the fluorescence.

Preferably, the block 20 is selectively disposed at a side portion, a lower portion and an upper portion of the sample receiving part 40 so as to irradiate the excitation light and detect the fluorescence.

Preferably, the detecting sensor 52 includes PMT (Photo multiplier tube), PD (photo diode) and CCD (Charged couple device).

Preferably, an optical fiber is inserted into the excitation light irradiating path 32 or the fluorescence path 51.

Preferably, an end of the optical fiber is worked into an ellipse shape so as to increase an incident amount of the excitation light or the fluorescence.

Preferably, the multi-channel bio reactor with fluorescence detector further includes a dichromatic mirror 54 which allows to irradiate the excitation light and detect the fluorescence using a single piece of the optical fiber.

Preferably, the block 20 is fixed to a moving table 61 so as to move left and right or forward and backward, so that the light irradiation part 30 and the optical detecting part 50 irradiate the light on the well 41 or detect the light from the well 41.

Further, the present invention provides a multi-channel bio reactor with fluorescence detector on-line monitoring apparatus, including a main body 110 in which a multi-channel bio reactor with fluorescence detector 100 is provided; a data transmitting part 120 which transmits data detected from the optical detecting part 50 of the multi-channel bio reactor with fluorescence detector 100 and receives a control signal for the multi-channel bio reactor with fluorescence detector 100; a data receiving part 130 which receives data transmitted from the data transmitting part 120 and transmits the control signal for the multi-channel bio reactor with fluorescence detector 100; and a micro-processor 140 which analyzes and stores the received data received from the data receiving part 130 and controls the multi-channel bio reactor with fluorescence detector 100.

Preferably, the main body 110 is formed with an air inlet port 112 through which external air is introduced and an air outlet port 113 through which air in the main body 110 is discharged, and includes a heater 116 which is provided at the air inlet port 112, an air inlet fan 114 which is disposed at a rear side of the heater 116 so as to suck air heated by the heater 116, an air inlet slot 151, 152 through which the air is introduced by the air inlet fan 114, an air outlet port 153 which is provided at an outer side of the air inlet slot 151, 152 and communicated with the air inlet slot 151, 152 so as to discharge the heated air inside the main body 110, and an air outlet fan 115 which is provided at the air outlet port 113 so as to discharge air in the main body 110 to an outside, and the main body 110 further includes a thermostat 150 for constantly maintaining an internal temperature in the main body 110.

Preferably, the multi-channel bio reactor with fluorescence detector on-line monitoring apparatus further includes an antifungal filter 160 is provided at the air inlet port 112 and the air outlet port 113 so as to filter internal air discharged from the main body 110.

Preferably, the multi-channel bio reactor with fluorescence detector on-line monitoring apparatus further includes a vibrator 170 which vibrates the sample receiving part 40 of the multi-channel bio reactor with fluorescence detector and thus stirs the sample received in the sample receiving part 40.

### Advantageous Effects

since the excitation lights which are respectively emitted from the plurality of light sources so as to have a difference wavelength is irradiated to the wells, it is possible to detect the fluorescence according to characteristics of the fluorescent dyes which generate the fluorescence by the concentration of dissolved oxygen, pH, the concentration of carbon dioxide, the concentration of specified ion and the like, and thus to analyze various characteristics at a time. Further, since the multiple samples are measured in a single device at a time while the sample receiving part having the plurality of wells is moved, it is possible to reduce the measuring time. Furthermore, since the multi-channel bio reactor with fluorescence detector of the present invention is controlled through on-line, it is possible to facilely control the multi-channel bio reactor with fluorescence detector and secure the stability. Furthermore, it is possible to control the plurality of the multi-channel bio reactor with fluorescence detectors and provide the optimum conditions for reacting the samples in the sample receiving part.

### BRIEF DESCRIPTION OF DRAWINGS

The above and other objects, features and advantages of the present invention will become apparent from the following description of preferred embodiments given in conjunction with the accompanying drawings, in which:

FIG. 1 is a perspective view showing a state that a sample receiving part is disposed in a main body casing of a multi-channel bio reactor with fluorescence detector according to the present invention.

FIG. 2 is a perspective view showing a detail structure of a thermostat according to the present invention.

FIG. 3 is a plane view of the detail structure of the thermostat according to the present invention.

FIG. 4 is a perspective view showing a state that a light source and a band pass filter are provided in a block of the multi-channel bio reactor with fluorescence detector according to the present invention.

FIG. 5 is a cross-sectional view showing a state that a well of the sample receiving part is disposed at an upper side of the block of the multi-channel bio reactor with fluorescence detector and excitation light is irradiated thereon according to the present invention.

FIG. 6 is a perspective view showing a state that the block disposed at a lower inner portion of the main body casing is moved according to the present invention.

FIG. 7 is a plane view of a well of the sample receiving part in the multi-channel bio reactor with fluorescence detector according to other embodiment of the present invention.

FIG. 8 is a cross-sectional view showing a state of irradiating excitation light and detecting fluorescence using a dichromatic minor in the multi-channel bio reactor with fluorescence detector according to the present invention.

FIG. 9 is a schematic view showing a structure of a multi-channel bio reactor with fluorescence detector on-line monitoring apparatus according to the present invention.

### DETAILED DESCRIPTION OF MAIN ELEMENTS

100: multi-channel bio reactor with fluorescence detector 1: main body casing
2: cover 10: light source
20: block 30: light irradiation part
31: light source coupling port 32: excitation light irradiating path
33: band pass filter 40: sample receiving part
41: well 42: fluorescent sensor film
50: optical detecting part 51: fluorescence path
52: detecting sensor 61: moving table
62: x-axial moving means 63: y-axial moving means
110: main body
120: data transmitting part 130: data receiving part
140: micro-processor 150: thermostat
160: antifungal filter 170: vibrator

### BEST MODE FOR CARRYING OUT THE INVENTION

Hereinafter, the embodiments of the present invention will be described in detail with reference to accompanying drawings.

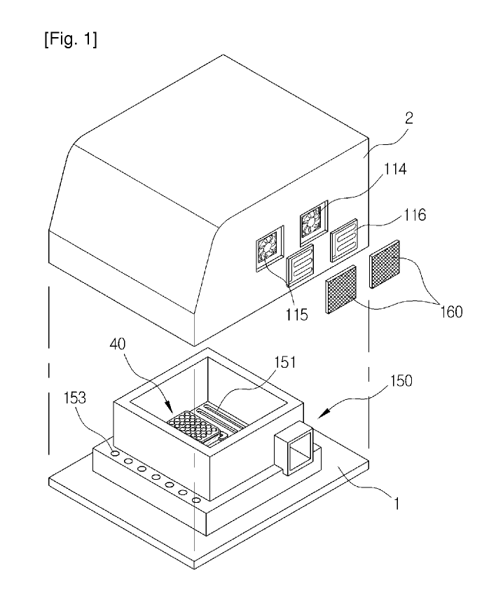

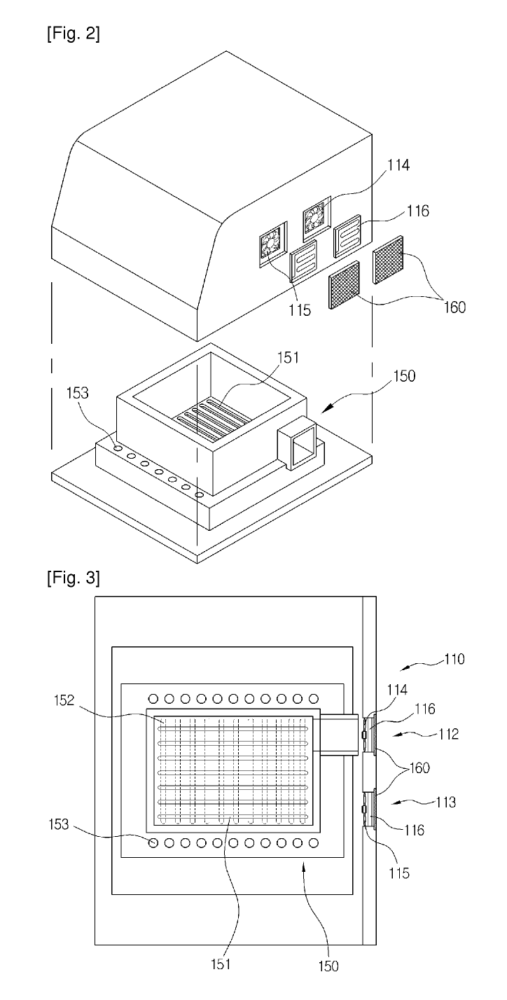

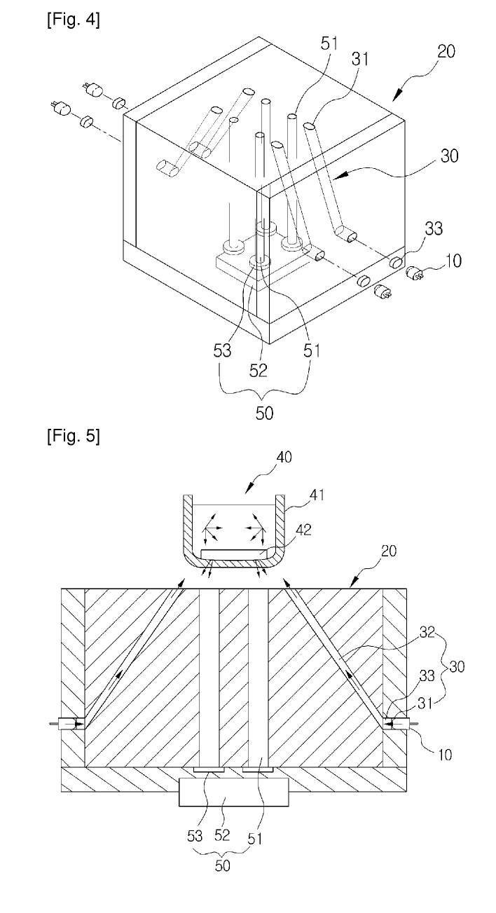

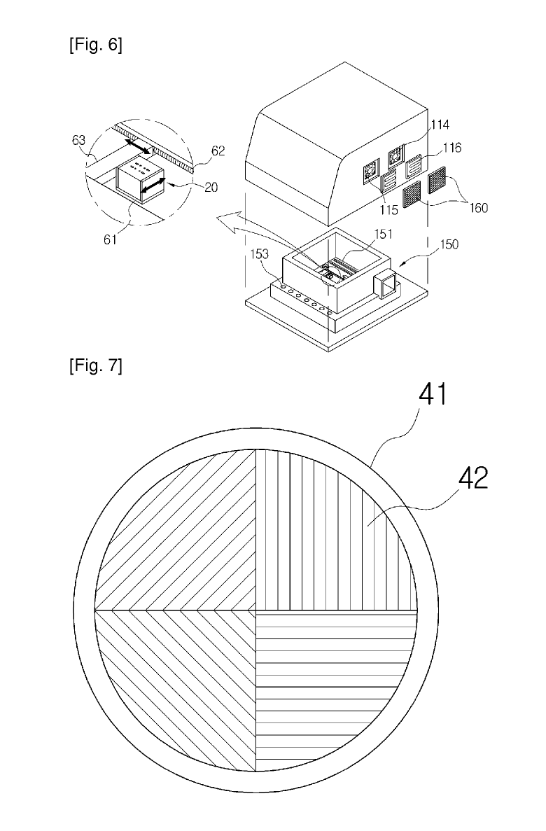

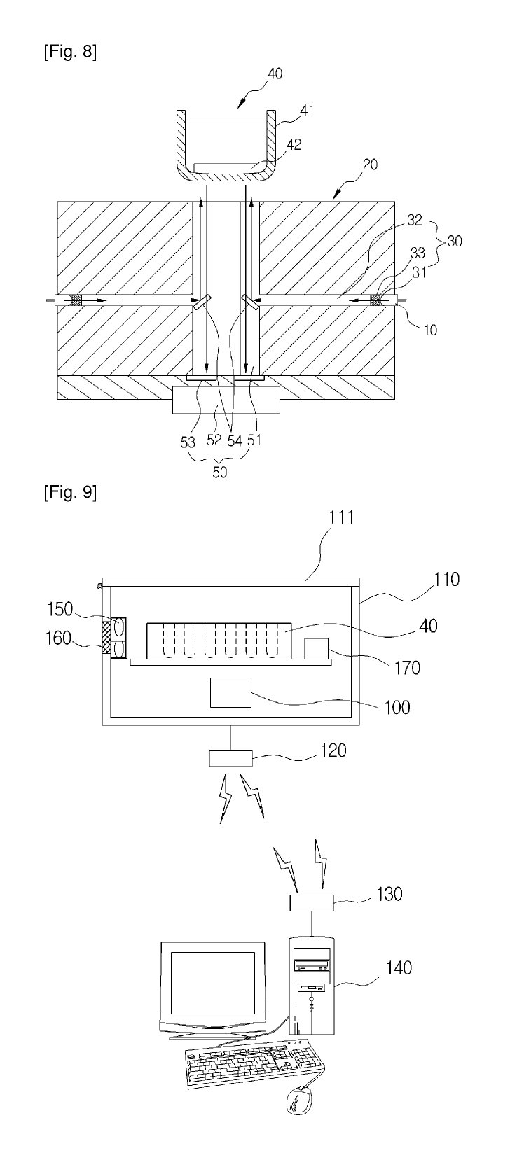

FIG. 1 is a perspective view showing a state that a sample receiving part is disposed in a main body casing of a multi-channel bio reactor with fluorescence detector according to the present invention, FIG. 2 is a perspective view showing a detail structure of a thermostat according to the present invention, FIG. 3 is a plane view of the detail structure of the thermostat according to the present invention, FIG. 4 is a perspective view showing a state that a light source and a band pass filter are provided in a block of the multi-channel bio reactor with fluorescence detector according to the present invention, FIG. 5 is a cross-sectional view showing a state that a well of the sample receiving part is disposed at an upper side of the block of the multi-channel bio reactor with fluorescence detector and excitation light is irradiated thereon according to the present invention, FIG. 6 is a perspective view showing a state that the block disposed at a lower inner portion of the main body casing is moved according to the present invention, FIG. 7 is a plane view of a well of the sample receiving part in the multi-channel bio reactor with fluorescence detector according to other embodiment of the present invention, and FIG. 8 is a cross-sectional view showing a state of irradiating excitation light and detecting fluorescence using a dichromatic minor in the multi-channel bio reactor with fluorescence detector according to the present invention.

As illustrated in drawings, the multi-channel bio reactor with fluorescence detector according to the present invention includes a light source 10 for emitting excitation light, a light irradiation part 30 for irradiating the excitation light emitted from the light source 10; a sample receiving part 40 in which the excitation light irradiated from the light irradiation part 30 is irradiated on a sample and which has a plurality of walls 41 for receiving a sample containing a fluorescent material; and an optical detecting part 50 for detecting fluorescence emitted from the sample received in the wall 41 of the sample receiving part 40.

The multi-channel bio reactor with fluorescence detector 100 has a main body casing 1. The main body casing 1 has a cover 2 disposed at an upper side thereof, so that the sample receiving part 40 in which a sample is accommodated is received in the main body casing 1 in a state the cover 2 is opened, and a darkroom in which light is not entered is maintained in state the cover 2 is closed.

In order to culture various microorganisms using the multi-channel bio reactor with fluorescence detector, it is important to maintain proper temperature according to a growth property of each microorganism. Therefore, the present invention provides a thermostat 150 for constantly maintaining the temperature in the sample receiving part, i.e., a small fluorescence detector.

In order to constantly maintain the temperature of the multi-channel bio reactor with fluorescence detector, as shown in FIGS. 2 and 3, the main body 110 is formed with an air inlet port 112 through which external air is introduced and an air outlet port 113 through which air in the main body 110 is discharged, and includes a heater 116 which is provided at the air inlet port 112, an air inlet fan 114 which is disposed at a rear side of the heater 116 so as to suck air heated by the heater 116, an air inlet slot 151, 152 through which the air is introduced by the air inlet fan 114, an air outlet port 153 which is provided at an outer side of the air inlet slot 151, 152 and communicated with the air inlet slot 151, 152 so as to discharge the heated air inside the main body 110, and an air outlet fan 115 which is provided at the air outlet port 113 so as to discharge air in the main body 110 to an outside. At this time, the thermostat 150 functions to introduce the external air into the main body 110 and discharge the internal air of the main body 110 using the air inlet fan 114 and the air outlet fan 115 so as to perform heat exchange therebetween, thereby constantly maintaining the temperature.

The air inlet port 112 is formed into a slit type so that hot air or cold air supplied from the outside is appropriately diffused at a front surface of the small fluorescence detector. In order to discharge the hot air or the cold air supplied to the fluorescence detector outside the detector, the air outlet ports 153 are arranged in a raw at a side of the slit type air inlet port 112, thereby discharging the supplied air to the inside of the main body 110. An antifungal filter 160 is provided at an outer side of the air inlet fan 114 and the air outlet fan 115 so as to prevent an inside of the small fluorescence detector from being contaminated by germs. The antifungal filter 160 filters the external air so as to remove dusts which may stain the sample receiving part upon the fluorescence analysis and also to prevent the sample receiving part from being contaminated by the germs, thereby improving accuracy of data analysis and reliability. The antifungal filter 160 is typically well-known in the art.

As described above, since the present invention has the constant-temperature and antifungal functions, it is possible to provide the optimum conditions for reacting the sample received in the sample receiving part of the multi-channel bio reactor with fluorescence detector.

Preferably, the present invention further includes a vibrator 170 which vibrates the sample receiving part 40 of the multi-channel bio reactor with fluorescence detector and thus stirs the sample received in the sample receiving part 40.

As illustrated in FIGS. 4 and 5, the light source 10 emits a desired light beam and includes a light emitting diode (LED), a laser diode (LD), a Xe-lamp, a tungsten lamp and so on.

The light irradiation part 30 includes a light source coupling port 31 which is coupled with the light source 10, an excitation light irradiating path 32 through which excitation light emitted from the light source 10 is transmitted from the light source coupling port 31, and a band pass filter 33 which is coupled to an end or an internal portion of the excitation light irradiating path 32 placed at an inside portion of the light source 10 so as to pass only the excitation light having a special wavelength emitted from the light source 10. The light irradiation portion 30 is disposed at a block which is formed into one body.

The light source coupling port 31 may be disposed at one side surface, a lower portion or an upper portion of the block 20. Further, the excitation light irradiating path 32 may be formed from the light source coupling port 31 toward the other side surface, an upper portion or a lower portion of the block 20 so that the excitation light emitted from the light source 10 can be irradiated through an entry portion formed at an end of the excitation light irradiating path 32. In case that the light source coupling port 31 is formed at a surface of the block 20 and the excitation light irradiating path 32 is formed at the other side of the block 20, the block 20 is disposed at a side surface of the sample receiving part 40 so as to detect fluorescence. In case that the excitation light irradiating path 32 is formed at the upper portion of the block 20, the block 20 is disposed at a lower side of the sample receiving part 40. In case that excitation light irradiating path 32 is formed at the lower portion of the block 20, the block 20 is disposed at an upper side of the sample receiving part 40.

In the drawing, the light source coupling port 31 is formed at one side surface of the block 20 and the excitation light irradiating path 32 is formed to be inclined toward the upper portion of the block 20.

As described above, the excitation light irradiating path 32 is formed at the surface of the block adjacent to the sample receiving part 40 so as to form an angle of 0 to 90° with respect to the light source coupling port 31.

Preferably, the light source coupling port 31 and the excitation light irradiating path 32 are provided in plural so as to be respectively irradiated with the excitation light emitted from the same light source, or the excitation lights independently emitted from difference light sources.

The band pass filter 33 is disposed at an end of the excitation light irradiating path 32 or in the excitation light irradiating path 32 positioned at an inner side of the light source 10. The band pass filter 33 functions to allow only the excitation light having a wavelength proper to the characteristics, such as concentration of dissolved oxygen, pH, concentration of carbon dioxide, and concentration of specified ion, to be passed.

The excitation light having a special wavelength, which passes through the band pass filter 33, is irradiated to the wall 41 of the sample receiving part 40.

The sample receiving part 40 is irradiated with the excitation light having the specific wavelength, which passes the band pass filter 33 of the light irradiation portion 30, and thus the sample in the sample receiving part 40 is irradiated with the excitation light.

As shown in FIGS. 1, 5 and 8, the sample receiving part 40 is disposed at an inner upper portion of the main body casing 1 and provided with the plurality of walls 41 in which the sample to be measured containing a fluorescent substance is accommodated.

Preferably, a fluorescent sensor film 42 for emitting only special fluorescence intended to be measured is attached to a bottom surface in each of the plurality of walls 41. At this time, the block 20 is preferably provided at a lower side of the sample receiving part 40.

The fluorescent sensor film 42 includes a sensor film formed of a fluorescent dye for detecting dissolved oxygen, a fluorescent dye for detecting pH, a fluorescent dye for detecting carbon dioxide, a fluorescent dye for detecting specified ion, and an optical sensor film using a principle of generating fluorescence when a biochemical material is combined with, for example, GFP (Green Fluorescent Protein) which is a protein emitting green fluorescence, RFP (Red Fluorescent Protein) which is a protein emitting red fluorescence or a quantum dot, or simultaneously existed along with it. The sensor film is fixedly attached to an inner bottom surface of each well 41, or the fluorescent dye is coated to have a predetermined thickness on the inner bottom surface of each well 41, thereby forming the sensor film. Therefore, if the excitation light having a specific wavelength passing through the band pass filter 33 is irradiated into the well 41, the sample received in the well 41 and the fluorescent dye contained in the fluorescent sensor film interacts with each other, and thus fluorescence which is in proportion or inverse proportion to concentration of the sample is generated.

The sensor film formed of one of the fluorescent dye for detecting dissolved oxygen, the fluorescent dye for detecting pH, the fluorescent dye for detecting carbon dioxide, the fluorescent dye for detecting specified ion and various fluorescent sensor films is provided as the fluorescence sensor film 42 at the inner bottom surface of one well 41, as shown in FIG. 5. Alternatively, in other embodiment of the present invention, as shown in FIG. 7, the sensor film formed of the fluorescent dye for detecting dissolved oxygen, the fluorescent dye for detecting pH, the fluorescent dye for detecting carbon dioxide, the fluorescent dye for detecting specified ion and the like is divided into multiple parts so that various kinds of the fluorescent dyes are provided together so as to measure various biologic characteristics at a time. In this case, the multiple light sources 10 corresponding to the number of divided parts are provided at the block 20 so that proper excitation lights can be respectively irradiated to each divided part. Also each band pass filter 33 which is differently controlled is provided so as to filter only the wavelength of the excitation light according to each characteristic. Furthermore, instead of the fluorescent dye that is dividedly coated on the inner bottom surface of the well 41, the sensor film which is mixed with the various fluorescent dyes or sensing materials which generates and senses the fluorescence may be used.

The optical detecting part 50 includes a fluorescence path 51 which is provided at the block 20 and through which the fluorescence emitted from the sample received in the well 41 of the sample receiving part 40 is transmitted, and a detecting sensor 52 which is coupled to an end of the fluorescence path 51 so as to detect the transmitted fluorescence.

The fluorescence path 51 functions to transmit the fluorescence emitted from the sample received in the well 41 of the sample receiving part 40. The detecting sensor 52 for detecting the transmitted fluorescence is provided at the end of the fluorescence path 51.

Preferably, the fluorescence path 51 and the detecting sensor 52 of the optical detecting part 50 are respectively provided in plural corresponding to the number of the divided parts.

As shown in FIGS. 4 and 5, the block 20 formed into a rectangular parallelepiped shape is disposed at an inner lower side of the main body casing 1 so as to irradiate the excitation light and detect the fluorescence while being moved to the lower side of each wall 41 in turn. A plurality of light sources 10 and band pass filters 33 are respectively provided at the block 20, and a plurality of excitation light irradiating paths 32 are formed in the block 20 so that the sample receiving part 40 of the block 20 is irradiated with the excitation light transmitted from each light source 10 and band pass filter 33. The light source 10 is coupled to an inlet portion of the excitation light irradiating path 32 and the band pass filter 33 is provided at an inner portion of the excitation light irradiating path 32, and the well 41 of the sample receiving part 40 is positioned to be adjacent to an outlet portion of the excitation light irradiating path 32. Further, at the block 20, there are provided the fluorescence path 51 for transmitting the fluorescence emitted from the sample received in the well 41, a band pas filter portion 53 for filtering only the fluorescence having the specific wavelength, and the detecting sensor 52 for detecting the transmitted fluorescence.

Preferably, an optical fiber is inserted into the excitation light irradiating path 32 or the fluorescence path 51 so as to transmit the excitation light or the fluorescence.

The outlet portion of the excitation light irradiating path 32 is worked into an ellipse shape so that the excitation light irradiated through the excitation light irradiating path 32 is input to the well 41 while being widely spread, whereby an incident surface area of the excitation light is increased.

In order to irradiate the excitation light and detect the fluorescence using a single piece of the optical fiber, as shown in FIG. 8, a fluorescence detection system further having a dichromatic mirror 54 may be used to selectively pass the beam.

The dichromatic minor 54 is disposed at an angle of 45 so as to reflect the excitation light irradiated through the excitation light irradiating path 32 to the sample receiving part 40. Also the dichromatic mirror 54 functions to transmit the fluorescence emitted from the sample received in the well 41 of the sample receiving part 40 and thus allow the fluorescence to be detected by the optical detecting part 50.

As shown in FIGS. 4 and 5, a plurality of the fluorescence paths 51 are vertically punched at a center portion of an upper surface of the block 20 adjacent to each well 41, and the detecting sensor 52 such as PMT (Photo multiplier tube), PD (photo diode) and CCD (Charged couple device) is coupled to a lower side of the fluorescence path 51 so as to detect and image the fluorescence detected by the fluorescence sensor film 42. The fluorescence signal can be analyzed in real-time through a computer and also monitored through on-line.

As shown in FIG. 6, the block 20 is movably disposed at an inner portion of the main body casing 1. To this end, a moving table 61 is horizontally provided at an inner center portion of the main body casing 1. The moving table 61 is coupled to an x-axial moving means 62 and a y-axial moving means 63 so as to move left and right or forward and backward. The block 20 is moved left and right or forward and backward by the moving table 61 and thus moved in turn at the lower side of each well 41 of the sample receiving part 40 so as to perform the fluorescence analysis.

In another embodiment of the present invention, the block 20 is fixedly provided, and the sample receiving part 40 is moved by the moving table 61 so as to measure each well 41 of the sample receiving part 40.

Hereinafter, a multi-channel bio reactor with fluorescence detector on-line monitoring apparatus according to the present invention will be described.

FIG. 9 is a schematic view showing a structure of a multi-channel bio reactor with fluorescence detector on-line monitoring apparatus according to the present invention.

The multi-channel bio reactor with fluorescence detector on-line monitoring apparatus according to the present invention measures various characteristics of a bio-chemical material, such as concentration of dissolved oxygen, pH, concentration of carbon dioxide, and concentration of specified ion, using fluorescence analysis, and also controls a multi-channel bio reactor with fluorescence detector through on-line. The multi-channel bio reactor with fluorescence detector on-line monitoring apparatus includes a main body 110 which is provided with a multi-channel bio reactor with fluorescence detector 100 comprised of a light source 10 for emitting excitation light, a sample receiving part 40 having a plurality of walls 41, and an optical detecting part 50 for detecting fluorescence emitted from a sample received in the wall of the sample receiving part 40; a data transmitting part 120 which transmits detected data and receives control signal for the multi-channel bio reactor with fluorescence detector 100; a data receiving part 130 which receives the transmitted data and transmits the control signal for the multi-channel bio reactor with fluorescence detector 100; and a micro-processor 140 which analyzes and stores the received data and controls the multi-channel bio reactor with fluorescence detector 100.

The multi-channel bio reactor with fluorescence detector 100 is disposed in the main body 110. The main body 110 receives the sample receiving part 40, in which a sample is accommodated, in its opened state, and maintains a darkroom, in which light is not entered, in its closed state.

The data transmitting part 120 functions to transmit data detected from the optical detecting part 50 of the multi-channel bio reactor with fluorescence detector 100 and also receive a control signal of the multi-channel bio reactor with fluorescence detector 100. The transmitted data is analyzed and then output by the micro-processor 140. The light source 10, the thermostat 150, the vibrator 170 and the moving table 61 are controlled by the received control signal of the multi-channel bio reactor with fluorescence detector 100.

The data receiving part 130 functions to receive the data transmitted from the data transmitting part 120 and also transmit the control signal of the multi-channel bio reactor with fluorescence detector 100.

The micro-processor 140 functions to analyze and store the data received from the data receiving part 130 and also control the multi-channel bio reactor with fluorescence detector 100.

According to the above-mentioned construction of the present invention, it is possible to facilely control the multi-channel bio reactor with fluorescence detector 100 through on-line and thus secure stability.

Further, since the multi-channel bio reactor with fluorescence detector on-line monitoring apparatus is used in a state that the plurality of main bodies are connected with each other, it is possible to control the multi-channel bio reactor with fluorescence detector.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

According to the present invention, since the excitation lights which are respectively emitted from the plurality of light sources so as to have a difference wavelength is irradiated to the wells, it is possible to detect the fluorescence according to characteristics of the fluorescent dyes which generate the fluorescence by the concentration of dissolved oxygen, pH, the concentration of carbon dioxide, the concentration of specified ion and the like, and thus to analyze various characteristics at a time. Further, since the multiple samples are measured in a single device at a time while the sample receiving part having the plurality of wells is moved, it is possible to reduce the measuring time. Furthermore, since the multi-channel bio reactor with fluorescence detector of the present invention is controlled through on-line, it is possible to facilely control the multi-channel bio reactor with fluorescence detector and secure the stability. Furthermore, it is possible to control the plurality of the multi-channel bio reactor with fluorescence detectors and provide the optimum conditions for reacting the samples in the sample receiving part.

1. A multi-channel fluorescence detector 100, comprising:
a light source 10 for emitting excitation light;
a light irradiation part 30 for irradiating the excitation light emitted from the light source 10;
a sample receiving part 40 in which the excitation light irradiated from the light irradiation part 30 is irradiated on a sample and which has a plurality of walls 41 for receiving a sample containing a fluorescent material; and
an optical detecting part 50 for detecting fluorescence emitted from the sample received in the wall 41 of the sample receiving part 40.

2. The multi-channel fluorescence detector according to claim 1, wherein the light irradiation part 30 is provided with a block 20 which is formed into one body, and comprises a light source coupling port 31 which is coupled with the light source 10, an excitation light irradiating path 32 through which excitation light emitted from the light source 10 is transmitted from the light source coupling port 31, and a band pass filter 33 which is coupled to an end or an internal portion of the excitation light irradiating path 32 placed at an inside portion of the light source 10 so as to pass only the excitation light having a special wavelength emitted from the light source 10.

3. The multi-channel fluorescence detector according to claim 2, wherein the optical detecting part 50 comprises a fluorescence path 51 which is provided at the block 20 of the light irradiation part 30 and through which the fluorescence emitted from the sample received in the well 41 of the sample receiving part 40 is transmitted, a band pass filter 53 which is disposed at the fluorescence path 51, and a detecting sensor 52 which is coupled to an end of the fluorescence path 51 so as to detect the transmitted fluorescence.

4. The multi-channel fluorescence detector according to claim 2, wherein the light source coupling port 31 and the excitation light irradiating path 32 are provided in plural so as to entirely or independently irradiate the excitation light.

5. The multi-channel fluorescence detector according to claim 2, wherein the excitation light irradiating path 32 is formed at the surface of the block adjacent to the sample receiving part 40 so as to form an angle of 0 to 90° with respect to the light source coupling port 31.

6. The multi-channel fluorescence detector according to claim 2, wherein the block 20 is disposed at a lower side of the sample receiving part 40, and a fluorescent sensor film 42 for passing only particular fluorescence emitted from the sample or a fluorescent material for sensing the fluorescence is attached to or coated on a bottom surface of the well 41.

7. The multi-channel fluorescence detector according to claim 6, wherein the fluorescent sensor film 42 is divided into or mixed with n kinds or more (n=1) so as to measure various characteristics of biochemical materials.

8. The multi-channel fluorescence detector according to claim 7, wherein the fluorescence path 51 and the detecting sensor 52 of the optical detecting part 50 is comprised of a single detector or a plurality of fluorescent sensor films 42 in which the fluorescent dye is divided or mixed so as to detect the fluorescence.

9. The multi-channel fluorescence detector according to claim 2, wherein the block 20 is selectively disposed at a side portion, a lower portion and an upper portion of the sample receiving part 40 so as to irradiate the excitation light and detect the fluorescence.

10. The multi-channel fluorescence detector according to claim 3, wherein the detecting sensor 52 comprises PMT (Photo multiplier tube), PD (photo diode) and CCD (Charged couple device).

11. The multi-channel fluorescence detector according to claim 3, wherein an optical fiber is inserted into the excitation light irradiating path 32 or the fluorescence path 51.

12. The multi-channel fluorescence detector according to claim 11, wherein an end of the optical fiber is worked into an ellipse shape so as to increase an incident amount of the excitation light or the fluorescence.

13. The multi-channel fluorescence detector according to claim 11, further comprising a dichromatic mirror 54 which allows to irradiate the excitation light and detect the fluorescence using a single piece of the optical fiber.

14. The multi-channel fluorescence detector according to claim 2, wherein the block 20 is fixed to a moving table 61 so as to move left and right or forward and backward, so that the light irradiation part 30 and the optical detecting part 50 irradiate the light on the well 41 or detect the light from the well 41.

15. A multi-channel fluorescence detector on-line monitoring apparatus, comprising:
a main body 110 in which a multi-channel fluorescence detector 100 according to claim 1 is provided;
a data transmitting part 120 which transmits data detected from the optical detecting part 50 of the multi-channel fluorescence detector 100 and receives a control signal for the multi-channel fluorescence detector 100;
a data receiving part 130 which receives data transmitted from the data transmitting part 120 and transmits the control signal for the multi-channel fluorescence detector 100; and
a micro-processor 140 which analyzes and stores the received data received from the data receiving part 130 and controls the multi-channel fluorescence detector 100.

16. The multi-channel fluorescence detector on-line monitoring apparatus according to claim 15, wherein the main body 110 is formed with an air inlet port 112 through which external air is introduced and an air outlet port 113 through which air in the main body 110 is discharged, and comprises a heater 116 which is provided at the air inlet port 112, an air inlet fan 114 which is disposed at a rear side of the heater 116 so as to suck air heated by the heater 116, an air inlet slot 151, 152 through which the air is introduced by the air inlet fan 114, an air outlet port 153 which is provided at an outer side of the air inlet slot 151, 152 and communicated with the air inlet slot 151, 152 so as to discharge the heated air inside the main body 110, and an air outlet fan 115 which is provided at the air outlet port 113 so as to discharge air in the main body 110 to an outside, and the main body 110 further comprises a thermostat 150 for constantly maintaining an internal temperature in the main body 110.

17. The multi-channel fluorescence detector on-line monitoring apparatus according to claim 16, further comprising an antifungal filter 160 is provided at the air inlet port 112 and the air outlet port 113 so as to filter internal air discharged from the main body 110.

18. The multi-channel fluorescence detector on-line monitoring apparatus according to claim 16, further comprising a vibrator 170 which vibrates the sample receiving part 40 of the multi-channel fluorescence detector and thus stirs the sample received in the sample receiving part 40.

19. The multi-channel fluorescence detector on-line monitoring apparatus according to claim 17, further comprising a vibrator 170 which vibrates the sample receiving part 40 of the multi-channel fluorescence detector and thus stirs the sample received in the sample receiving part 40.
